(19) United States
(12) Patent Application Publication
(10) Pub. No.: US 2005/0279847 A1
(43) Pub. Date: Dec. 22, 2005

(54) Hot water circulating pump having water heating unit, and hot water mat using the same

(75) Inventor: Ki Ho Kim, Milyang-City (KR)

Correspondence Address: ST. ONGE STEWARD JOHNSTON & REENS, LLC, 986 BEDFORD STREET, STAMFORD, CT, 06905-5619, US

(73) Assignee: SM Co., Ltd., Kyeonnam (KR)

(21) Appl. No.: 11/157,678

(22) Filed: Jun. 21, 2005

(30) Foreign Application Priority Data
Jun. 21, 2004 (KR) 2004-45945

(51) Int. Cl. G05D 23/00

(52) U.S. Cl. 237/2 A

(57) ABSTRACT

A hot water circulating pump having a water heating unit, and a hot water mat using the same are provided. The hot water circulating pump is disposed outside of the water heating unit to prevent each part of the circulating pump from being damaged due to water leakage into the circulating pump. The hot water mat is improved in structure to allow the hot water tube to be disposed within the hot water mat, thereby providing simplicity and convenience in assembly.

This application claims priority of Korean Patent Application No. 2004-45945 filed Jun. 21, 2004.

### FIELD OF THE INVENTION

The present invention relates to a hot water circulating pump for circulating hot water using a hot water mat, and more particularly, to a hot water circulating pump having a water heating unit and disposed outside of the water heating unit to prevent water leakage into the hot water circulating pump, and a hot water mat using the hot water circulating pump and adapted to allow a hot water tube connected to the circulating pump to be easily inserted into the hot water mat.

### DESCRIPTION OF THE RELATED ART

As well known in the art, a hot water circulating pump refers to an apparatus disposed at a hot water mat and including a motor generating a driving force; and an impeller connected to a rotation shaft of a motor and rotating in association with the rotation shaft, and supplying hot water to the hot water mat. In general, the hot water circulating pump is disposed inside of a water heating unit (boiler) and supplies hot water at a predetermined temperature to the hot water mat. A related technology of the hot water circulating pump has been known in the art and accordingly, its detailed description will be omitted. The hot water circulating pump is in detail disclosed in Korean Patent Publication No.: 10-2004-0019606 entitled “WATER PUMP INSTALLED IN HOT WATER BOILER FOR MAT CIRCULATION” (Hereinafter, referred to as “Prior Art”).

However, in the Prior Art, the water pump (hot water circulating pump) itself is installed inside of the hot water boiler (that is, inside of water heating unit), that is, in hot water. Therefore, the hot water circulating pump has a drawback of water leakage in its parts. Due to this drawback, when the pump is manufactured, a separate process of preventing water leakage (a process of enhancing airtightness) is required, thereby degrading an efficiency of process and increasing a manufacture cost of the pump due to the airtightness of each part.

In the hot water mat, the hot water tube is connected to each of an inlet port and an outlet port of the boiler, to forcibly circulate hot water using a driving force of the hot water circulating pump. The conventional hot water mat has a drawback in that due to its simple construction where the hot water tube is laid on the cushionable bed at a predetermined interval, a process of laying the hot water tube on the cushionable bed is much complicated.

### SUMMARY OF THE INVENTION

Accordingly, the present invention is directed to a hot water circulating pump having a water heating unit, and a hot water mat using the same that substantially overcome one or more of the limitations and disadvantages of the conventional art.

An object of the present invention is to provide a hot water circulating pump having a water heating unit and disposed outside of the water heating unit to prevent each part of the circulating pump from being damaged due to water leakage into the circulating pump, and a hot water mat using the same.

Another object of the present invention is to provide a hot water circulating pump having a water heating unit, which has a heater improved in structure, and a hot water mat using the same.

A further another object of the present invention is to provide a hot water circulating pump not requiring a separate process against water leakage in its manufacture, and a hot water mat using the same.

A still further another object of the present invention is to provide a hot water circulating pump, and a hot water mat using the same, in which the hot water mat is improved in structure to allow a hot water tube to be disposed within the hot water mat, thereby providing simplicity and convenience in assembly.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims as well as the appended drawings.

To achieve the above and other objects and advantages, and in accordance with the purpose of the invention, as embodied and broadly described herein, there is provided a hot water circulating pump connected to a hot water mat, and forcibly circulating hot water to the hot water mat using an impeller rotating by a driving force of a motor, the pump including: a housing disposed between the motor and the impeller, and having a heating space for heating water and generating hot water therein; a hot plate attached to a bottom of the housing to heat water, and having a through-hole at its center to introduce the hot water to the impeller; and a water heating unit having a heater attached to a bottom of the hot plate and heating the hot plate using a PTC (Positive Temperature Coefficient) element, which generates heat by external power.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to aid in understanding the invention and are incorporated into and constitute a part of this application, illustrate embodiment(s) of the invention and together with the description serve to explain the principles of the invention. In the drawings:

FIG. 1 is a disassembled and perspective view illustrating a hot water circulating pump having a water heating unit according to the present invention;

FIG. 2 is a section view illustrating the hot water circulating pump of FIG. 1;

FIG. 3 is a perspective view illustrating the heater of FIG. 1;

FIG. 4 is a section view taken along line A-A of FIG. 3;

FIG. 5 is a perspective view illustrating a hot water mat using the hot water circulating pump of FIG. 1 according to the first embodiment of the present invention;

FIG. 6 is a section view taken along line B-B of FIG. 5;

FIG. 7 is a perspective view illustrating a hot water mat using the hot water circulating pump of FIG. 1 according to the second embodiment of the present invention;

FIG. 8 is a section view taken along line C-C of FIG. 7;

FIG. 9 is a plan view illustrating a hot water mat using the hot water circulating pump of FIG. 1 according to the third embodiment of the present invention; and

FIG. 10 is a perspective view illustrating a portion taken from the hot water mat of FIG. 9.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numerals will be used throughout the drawings to refer to the same or like parts.

The present invention provides a hot water circulating pump having a water heating unit and disposed outside of the water heating unit functioning as a boiler, thereby overcoming a conventional drawback of water leakage, which has been caused in case where the hot water circulating pump has been disposed inside of the water heating unit. Further, the present invention provides the hot water circulating pump and a hot water mat using the same, in which the hot water mat is improved in structure, thereby greatly facilitating the installation of a hot water tube in the hot water mat.

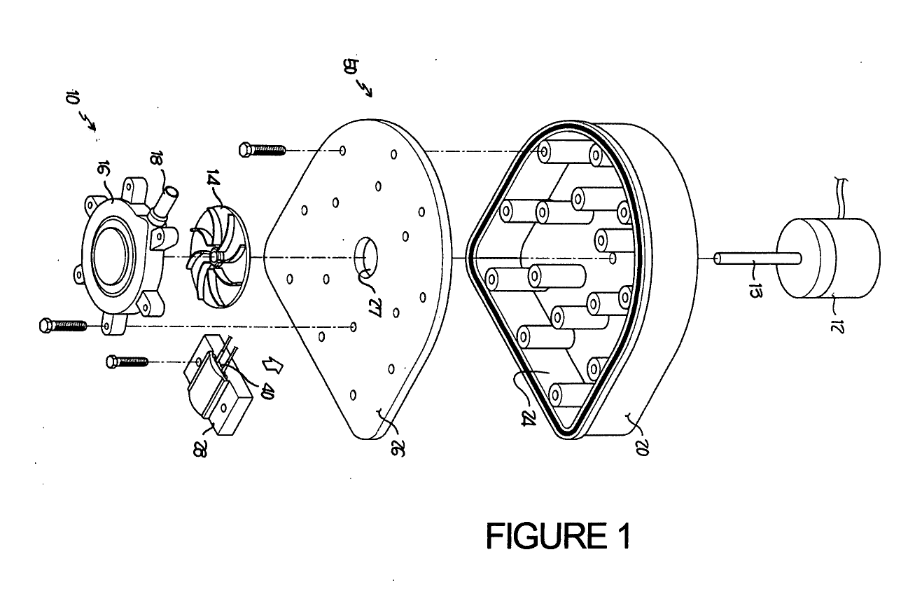

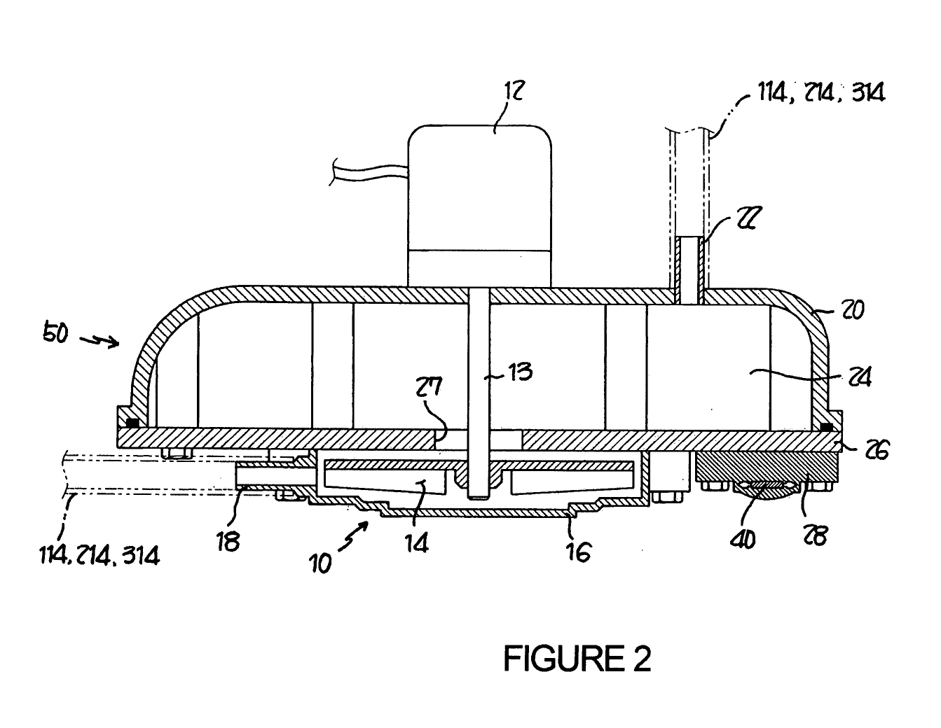

FIGS. 1 and 2 illustrate the hot water circulating pump 10 according to the present invention.

Referring to FIGS. 1 and 2, the inventive hot water circulating pump 10 includes a motor 12 receiving external power and driven by the received power; and an impeller 14 connected with a rotation shaft 13 of the motor 12 and rotating in association with the rotation shaft 13. A cover 16 has an outlet port 18 at its one side. The cover 16 is assembled with the impeller 14, and uses a rotation force of the impeller 14 to forcibly supply hot water to hot water tubes 114, 214 and 314 of later described hot water mats 100, 200 and 300 through the outlet port 18.

In the inventive hot water circulating pump 10, the water heating unit 50 is preferably disposed between the motor 12 and the impeller 14.

The water heating unit 50 functions as the boiler to heat water supplied to the hot water mats 100, 200 and 300. The water heating unit 50 includes a housing 20 having a heating space 24 and introducing water through an inlet port 22 provided at its upper side and heating the introduced water therein; and a hot plate 26 serving as a bottom of the housing 20. The housing 20 and the hot plate 26 form the exterior of the water heating unit 50. A through-hole 27 is provided at a center of the hot plate 26, and enables hot water to pass toward the impeller 14 provided at a lower side of the hot plate 26. In other words, the motor 12 is disposed at an upper side of the housing 20 and the impeller 14 is disposed at a lower side of the hot plate 26 such that the hot water circulating pump 10 is disposed outside of the water heating unit 50, thereby preventing the hot water circulating pump 10 from being damaged due to water leakage.

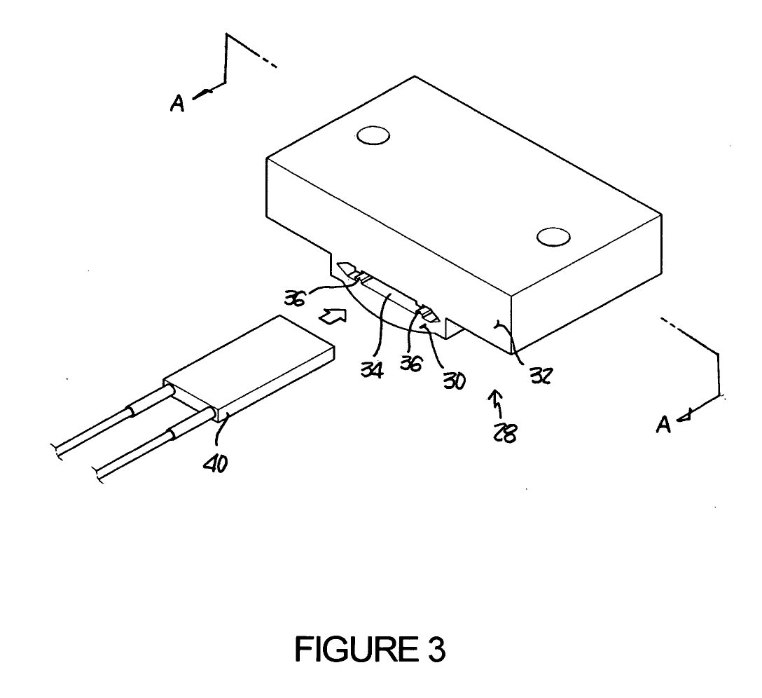

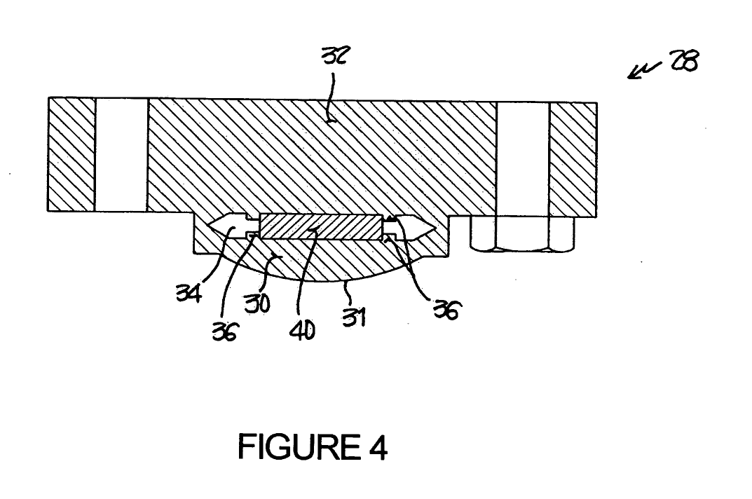

A heater 28 is stuck to one side of the hot plate 26 to heat the hot plate 26. A detailed structure of the heater 28 will be easily understood with reference to FIGS. 3 and 4.

As shown in FIGS. 3 and 4, the heater 28 includes a PTC element fixing unit 30 having a slide groove 34 for inserting a Positive Temperature Coefficient (PTC) element 40 generating heat by the external power; and a heat transmitter 32 integrated with the PTC element fixing unit 30 and stuck to a bottom of the hot plate 26 to transmit a generated heat from the PTC element 40 to the hot plate 26. The heat transmitter 32 preferably has a larger thickness than the hot plate 26. This larger thickness is to allow the heat transmitter 32 to more uniformly transmit the generated heat to the hot plate 26. Due to the larger thickness of the heat transmitter 32, the hot plate 26 can advantageously have a smaller thickness than the heat transmitter 32.

The PTC element fixing unit 30 is preferably rounded on its upper portion to have a round surface 31. In other words, when the PTC element 40 is inserted, pressed and fitted (compressed) into the slide groove 34, the round surface 31 of the PTC element fixing unit 30 allows pressure to be uniformly applied into the slide groove 34. Accordingly, the PTC element 40 is more uniformly stuck into the slide groove 34, thereby increasing a cohesive force between them. The slide groove 34 is preferably narrowed and gathered at both sides and between upper and lower surfaces of the PTC element fixing unit 30, to have shapes of “<” and “>”. These shapes allow the slide groove 34 to be pressed only at its both sides when the PTC element fixing unit 30 is pressed by the external force.

Guide jaws 36 are spaced apart from a center of the slide groove 34, and projected from the PTC element fixing unit 30. The guide jaw 36 guides and places the PTC element 40 to be in an exact central position of the slide groove 34 without eccentricity.

In other words, in the present invention, the hot water circulating pump 10 can be disposed outside of the water heating unit 50, thereby facilitating a use of the hot water circulating pump 10 without danger of water leakage, and the heater 28 mounted on the water heating unit 50 can be improved in structure, thereby effectively heating the introduced water.

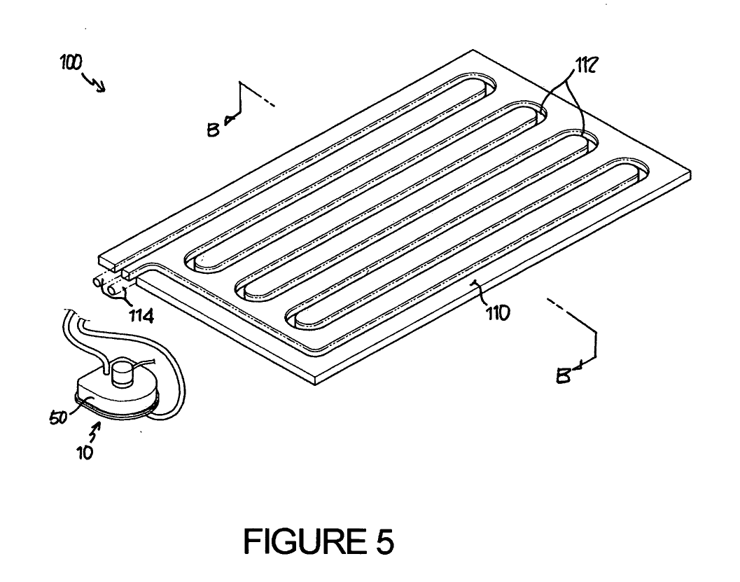

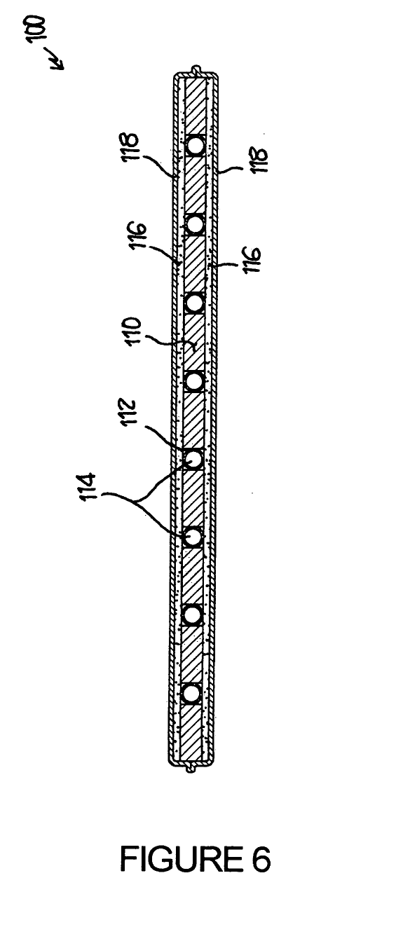

FIGS. 5 and 6 illustrate the structure of the hot water mat 100 using the hot water circulating pump 10 having the water heating unit 50 according to the first embodiment of the present invention.

As shown in FIGS. 5 and 6, the hot water mat 100 has a cushionable bed 110. The cushionable bed 110 is preferably formed of expanded polyethylene (PE) foam. It is desirable that the cushionable bed 110 is punched to provide guide through-holes 112 spaced apart from one another and zigzag-shaped. This is to allow the hot water tube 114 to be fitted and disposed into the guide through-hole 112, thereby simply installing the hot water tube 114. The hot water tube 114 is connected to each of the inlet port 22 of the water heating unit 50 (that is, the housing 20) and the outlet port 18 of the hot water circulating pump 10 (that is, the cover 16), to circulate hot water in the hot water mat 100.

An unwoven fabric 116 and an outer case 118 are sequentially covered and sewn on each of upper and lower surfaces of the cushionable bed 112 having the hot water tube 114 installed therein, to complete one article. The above-constructed hot water mat 100 is used as a mattress used for a bed and the like.

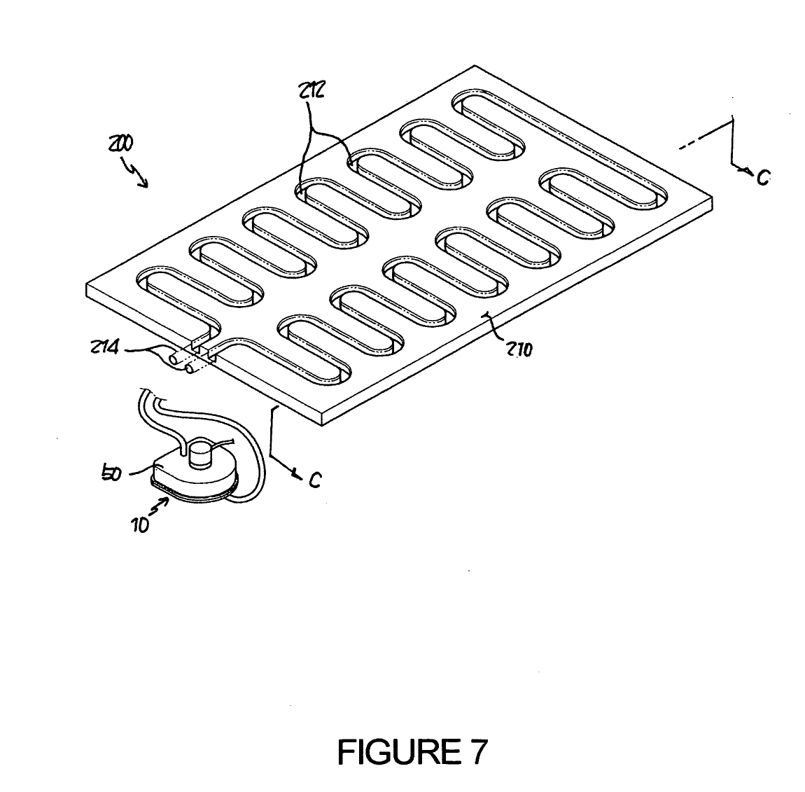

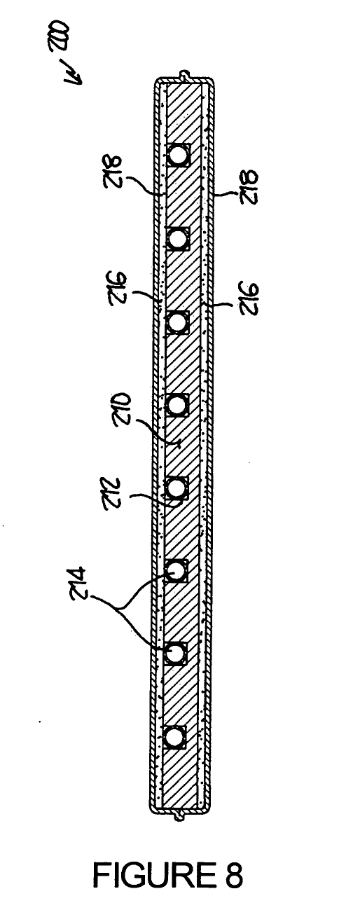

FIGS. 7 and 8 illustrate a structure of a hot water mat 200 using the hot water circulating pump 10 having the water heating unit 50 according to the second embodiment of the present invention.

As shown in FIGS. 7 and 8, the hot water mat 200 has a cushionable bed 210. The cushionable bed 210 is preferably formed of synthetic resin, unlike the cushionable bed 110 of the first embodiment. It is desirable that the cushionable bed 210 has an insertion groove 212 spaced apart from one another and zigzag-shaped. This is to allow the hot water tube 214 to be inserted and disposed in the insertion groove 212, thereby minimizing complexity in the installation of the hot water tube 214, like the guide through-hole 112 of the first embodiment. The inserted hot water tube 214 is connected to each of the inlet port 22 of the housing 20 and the outlet port 18 of the cover 16, to circulate hot water in the hot water mat 200.

An unwoven fabric 216 and an outer case 218 are sequentially covered and sewn on each of upper and lower surfaces of the cushionable bed 210 having the hot water tube 114 installed therein, in order to complete one product. The above-constructed hot water mat 200 is manufactured to have a smaller size unlike the hot water mat 100, and is used as a hot pack therapy unit for stimulating a specific portion of a human body.

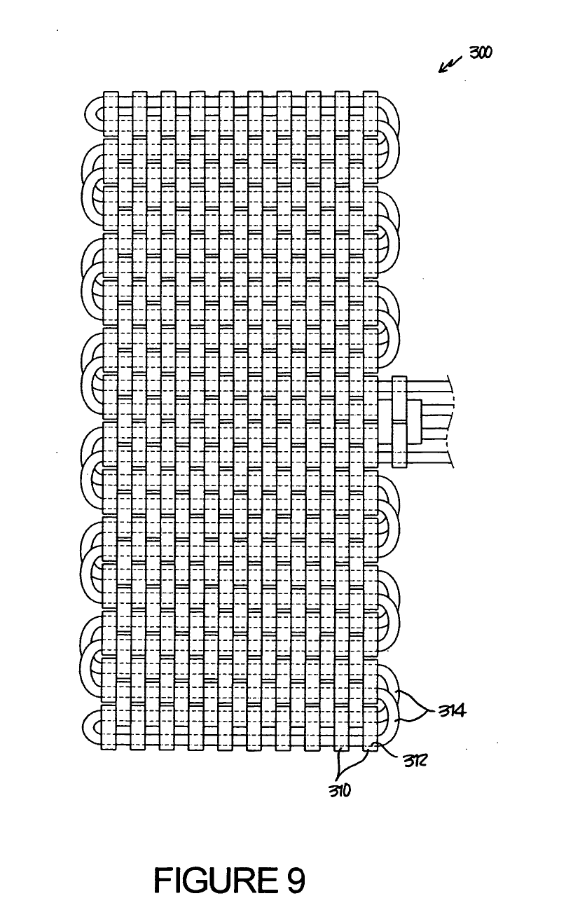

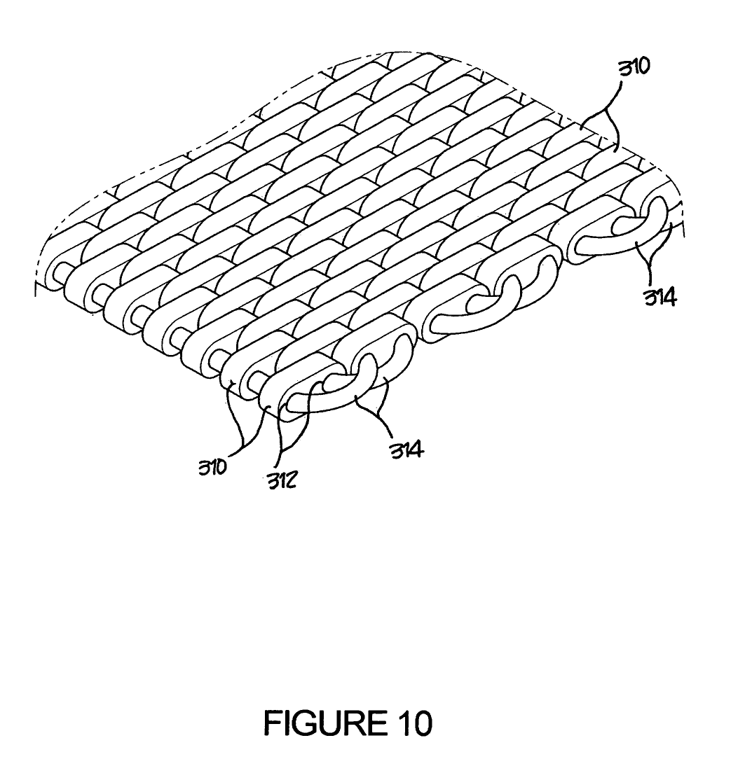

FIGS. 9 and 10 illustrate a structure of a hot water mat 300 using the hot water circulating pump 10 of the water heating unit 50 according to the third embodiment of the present invention.

As shown in FIGS. 9 and 10, the inventive hot water mat 300 includes a plurality of unitary link chains 310 each having a plurality of connection through-holes 312. A hot water tube 314 is inserted into the connection through-hole 312 of the unitary link chain 310, and connects the unitary link chains 310 with one another, to circulate hot water through the water heating unit 50 and the hot water circulating pump 10. The above construction of the hot water mat 300 using the plurality of unitary link chains 310 connected with one another is to allow the hot water mat 300 to be freely bent up and down, thereby seeking a user's convenience. The above-constructed hot water mat 300 is manufactured to have a smaller size, and is used as the hot pack therapy unit for stimulating the specific portion of the human body.

It is desirable that the hot water circulating pump 10 is installed at each of the above-structured hot water mats 100, 200 and 300. However, it is well known to those having an ordinary skill in the art that a “T”-shaped nipple (not shown) can be connected to the hot water circulating pump 10 according to need to concurrently supply hot water, which is heated by the water heating unit 50, to at least two hot water mats through the nipple.

As described above, the present invention has an advantage in that the hot water circulating pump is disposed outside of the water heating unit to prevent each part of the circulating pump from being damaged due to water leakage into the circulating pump.

Further, the present invention has an effect in that the hot water circulating pump does not require a separate process against water leakage in its manufacture, thereby increasing an efficiency of process.

Furthermore, the present invention has an effect in that the hot water mat is improved in structure to allow the hot water tube to be disposed within the hot water mat, thereby providing simplicity and convenience in assembly.

It will be apparent to those skilled in the art that various modifications and variations can be made in the present invention. Thus, it is intended that the present invention covers the modifications and variations of this invention provided they come within the scope of the appended claims and their equivalents.

1. A hot water circulating pump connected to a hot water mat, and forcibly circulating hot water to the hot water mat using an impeller rotating by a driving force of a motor, the pump comprising:
a housing disposed between the motor and the impeller, and having a heating space for heating water and generating hot water therein therein;
a hot plate attached to a bottom of the housing to heat water, and having a through-hole at its center to introduce the hot water to the impeller; and
a water heating unit having a heater attached to a bottom of the hot plate and heating the hot plate using a PTC (Positive Temperature Coefficient) element, which generates heat by external power.

2. The pump according to claim 1, wherein the heater has a PTC element fixing unit having a slide groove for inserting the PTC element, and the PTC element fixing unit is rounded on its upper portion to have a round surface.

3. The pump according to claim 2, wherein the slide groove has guide jaws projected from the PTC element fixing unit and guiding and placing the PTC element to be in its exact central position, and the slide groove is narrowed and gathered at both sides and between upper and lower surfaces of the PTC element fixing unit.

4. The pump according to claim 1, wherein the hot water mat comprises:
a cushionable bed having a guide through-hole punched and provided in a zigzag shape;
a hot water tube fitted into and along the guide through-hole and connected to the hot water circulating pump, for circulating hot water; and
an unwoven fabric and an outer case sequentially covered on each of upper and lower surfaces of the cushionable bed.

5. The pump according to claim 1, wherein the hot water mat comprises:
a cushionable bed having an insertion groove provided in a zigzag shape;
a hot water tube fitted into the insertion groove and connected to the hot water circulating pump, for circulating hot water; and
an unwoven fabric and an outer case sequentially covered on each of upper and lower surfaces of the cushionable bed.

6. The pump according to claim 1, wherein the hot water mat has a plurality of unitary link chains each having at least one connection through-hole, and
wherein a hot water tube connected to the hot water circulating pump and circulating hot water is fitted into the connection through-hole and interconnects the plurality of unitary link chains with one another.

7. A hot water mat having a hot water circulating pump, the mat comprising:
a cushionable bed having a guide through-hole punched and provided in a zigzag shape;
a hot water tube fitted into and along the guide through-hole and connected to the hot water circulating pump, for circulating hot water; and
an unwoven fabric and an outer case sequentially covered on each of upper and lower surfaces of the cushionable bed.

8. A hot water mat having a hot water circulating pump, the mat comprising:
a cushionable bed having an insertion groove provided in a zigzag shape;
a hot water tube fitted into the insertion groove and connected to the hot water circulating pump, for circulating hot water; and
an unwoven fabric and an outer case sequentially covered on each of upper and lower surfaces of the cushionable bed.

9. A hot water mat having a hot water circulating pump,
wherein the mat has a plurality of unitary link chains each having at least one connection through-hole, and
wherein a hot water tube connected to the hot water circulating pump and circulating hot water is fitted into the connection through-hole and interconnects the plurality of unitary link chains with one another.
